(19) United States
(12) Patent Application Publication
(10) Pub. No.: US 2025/0117695 A1
(43) Pub. Date: Apr. 10, 2025

(54) MACHINE LEARNING SENTIMENT ANALYSIS FOR SELECTIVE RECORD PROCESSING

(71) Applicant: Capital One Services, LLC, McLean, VA (US)

(72) Inventors: Varun GADH, Brooklyn, NY (US); Alan FRENCH, New York, NY (US)

(21) Appl. No.: 18/483,955

(22) Filed: Oct. 10, 2023

(51) Int. Cl. G06N 20/00

(52) U.S. Cl. CPC G06N 20/00

(57) ABSTRACT

In some implementations, a device may receive a candidate record for processing. The device may generate, using a machine learning model associated with determining a sentiment value, a determination of the sentiment value for the candidate record. The device may determine whether the sentiment value satisfies a threshold. The device may select a first processing action associated with the candidate record or a second processing action associated with the candidate record based on whether the sentiment value satisfies the threshold. The device may transmit, based on selecting the first processing action or the second processing action, one or more messages associated with causing the first processing action or the second processing action to be performed.

### BACKGROUND

A detection system may use machine learning or other artificial intelligence techniques to accurately classify a data record. For example, a detection system may analyze a request for a login to a system and determine whether the request is valid. To enable analysis of a request, the detection system may train a machine learning model on a dataset identifying hundreds, thousands, or millions of requests. The detection system performs feature extraction to extract relevant information from the dataset and represent the relevant information in a numerical format. The detection system trains a machine learning model to recognize patterns in the numerical format of the relevant information and stores the patterns as a set of weights or other values. When the detection system receives a request for analysis, the detection system can extract information from the request and apply the set of weights or other values to generate a determination.

### SUMMARY

Some implementations described herein relate to a system for machine learning based processing. The system may include one or more memories and one or more processors communicatively coupled to the one or more memories. The one or more processors may be configured to obtain a training dataset including information associated with a set of processed records. The one or more processors may be configured to train, using the training dataset, a machine learning model to determine a sentiment value associated with a candidate record that is queued for processing. The one or more processors may be configured to receive the candidate record for processing. The one or more processors may be configured to generate, using the machine learning model, a determination of the sentiment value for the candidate record. The one or more processors may be configured to determine whether the sentiment value satisfies a threshold. The one or more processors may be configured to selectively perform a first processing action associated with the candidate record or a second processing action associated with the candidate record based on whether the sentiment value satisfies the threshold.

Some implementations described herein relate to a non-transitory computer-readable medium that stores a set of instructions. The set of instructions, when executed by one or more processors of a device, may cause the device to obtain a training dataset including information associated with a set of processed records. The set of instructions, when executed by one or more processors of the device, may cause the device to train, using the training dataset, a machine learning model to determine a sentiment value associated with a candidate record that is queued for processing. The set of instructions, when executed by one or more processors of the device, may cause the device to receive the candidate record for processing. The set of instructions, when executed by one or more processors of the device, may cause the device to generate, using the machine learning model, a determination of the sentiment value for the candidate record. The set of instructions, when executed by one or more processors of the device, may cause the device to determine whether the sentiment value satisfies a threshold. The set of instructions, when executed by one or more processors of the device, may cause the device to selectively perform a first processing action associated with the candidate record or a second processing action associated with the candidate record based on whether the sentiment value satisfies the threshold. The set of instructions, when executed by one or more processors of the device, may cause the device to monitor a client device to determine a result of selectively performing the first processing action or the second processing action. The set of instructions, when executed by one or more processors of the device, may cause the device to update the machine learning model based on the result of selectively performing the first processing action or the second processing action.

Some implementations described herein relate to a method. The method may include receiving, by a device, a candidate record for processing. The method may include generating, using a machine learning model associated with determining a sentiment value, a determination of the sentiment value for the candidate record. The method may include determining, by the device, whether the sentiment value satisfies a threshold. The method may include selecting, by the device, a first processing action associated with the candidate record or a second processing action associated with the candidate record based on whether the sentiment value satisfies the threshold. The method may include transmitting, by the device and based on selecting the first processing action or the second processing action, one or more messages associated with causing the first processing action or the second processing action to be performed.

### BRIEF DESCRIPTION OF THE DRAWINGS

FIGS. 1A-1C are diagrams of an example implementation associated with machine learning sentiment analysis for selective record processing, in accordance with some embodiments of the present disclosure.

FIG. 2 is a diagram illustrating an example of training and using a machine learning model in connection with machine learning sentiment analysis, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with machine learning sentiment analysis, in accordance with some embodiments of the present disclosure.

FIG. 5 is a flowchart of an example process associated with machine learning sentiment analysis for selective record processing, in accordance with some embodiments of the present disclosure.

### DETAILED DESCRIPTION

The following detailed description of example implementations refers to the accompanying drawings. The same reference numbers in different drawings may identify the same or similar elements.

Systems may use machine learning for fraud detection to ensure that security is maintained within a system. For example, a system may use machine learning to identify fraudulent requests for records to be processed, such as fraudulent logins to a system, fraudulent entries in a database, or fraudulent edits to a document, among other examples. As another example, a system may use machine learning to identify a fraudulent request that a transaction be completed. In each case, the system is trained to use information associated with the request to determine whether a person, other than an authorized person, is associated with the request. In other words, the system is trained to detect deviations from a pattern learned for a first person (who is authorized to use a particular credit card), which indicate that the request is being made by a second person (who is not authorized to use the particular credit card). Accurate fraud detection improves security, thereby avoiding resource utilization associated with investigation, mitigation of damage, and/or refunds, such as processing resources, financial resources, or time resources.

However, similar resource utilizations may also occur when an authorized user is responsible for a request that the authorized user later seeks to undo. A person may regret a purchase for many reasons, such as the person having made the purchase while in an emotional (or otherwise compromised state). In other words, although a purchase is not fraudulent (e.g., the purchase is made by an authorized user), the purchase is, nevertheless, not desired by the authorized user. As an example, when a credit card user makes a late-night purchase of an item that the credit card user later regrets, the credit card user may request a return of the item. Requesting a return results in a usage of computing resources (as well as environmental resources) to issue a return label for the item, return ship the item, restock the item, re-add the item to a shopping portal, and/or issue a refund for the item. As shopping becomes increasingly easy, through the use of credit cards, mobile device payment systems, and/or biometric payment systems, among other examples, such regretted purchases are likely to increase, resulting in increasing environmental damage and computing resource utilization associated with returns, product wastage (e.g., throwing away unwanted items), or order cancellation.

Some implementations described herein enable use of sentiment analysis to detect emotion-based requests for record processing. For example, a record processing system may detect a request to process a record, such as a request to complete a transaction, and may determine whether the request is associated with a sentiment value that satisfies a threshold (e.g., indicating a negative emotional state associated with the record processing). In this case, when the record processing system determines that the sentiment value satisfies the threshold, the record processing system may reject or otherwise delay processing the record. In another example, the record processing system may receive a request to login to a system, modify entries in a database, modify a document, or perform another action and may determine whether to process a record associated with the request based on a sentiment value. For example, the record processing system may reject access to a database or may prevent edits to a document when a user is determined to be in an emotional state. In this way, by using sentiment analysis to determine whether to process a record, the record processing system reduces a likelihood of an emotional state of a user resulting in a regretted action, such as a regretted purchase, a regretted usage of a database, or a regretted edit to a document, among other examples. Further, by using the sentiment analysis to determine whether to process a record, the record processing system avoids a use of computing resources or environmental resources associated with undoing a result of a regretted request associated with the record. For example, the record processing system reduces utilization of processing resources or environmental resources associated with processing a refund, providing a return, reverting a document, or cleaning a database, among other examples.

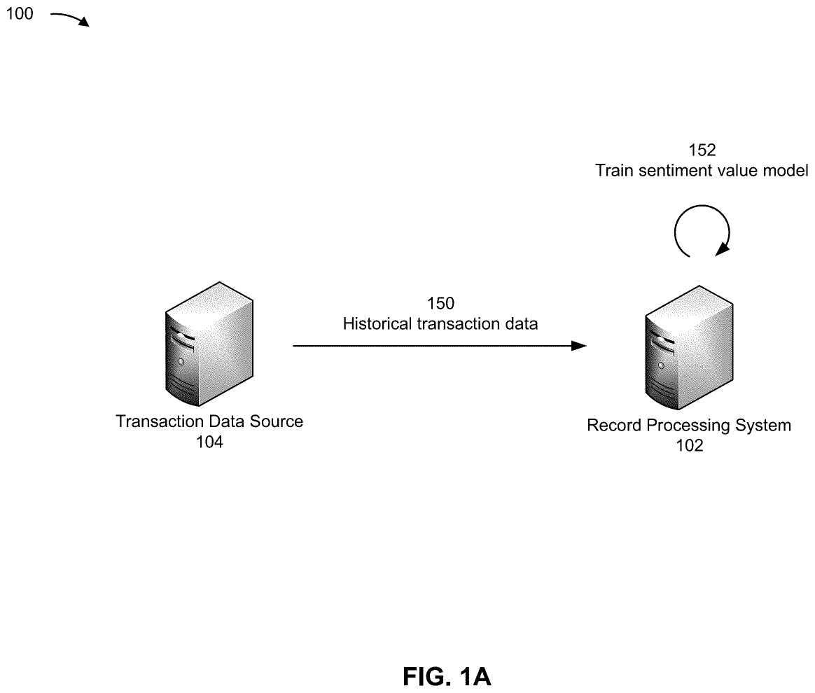

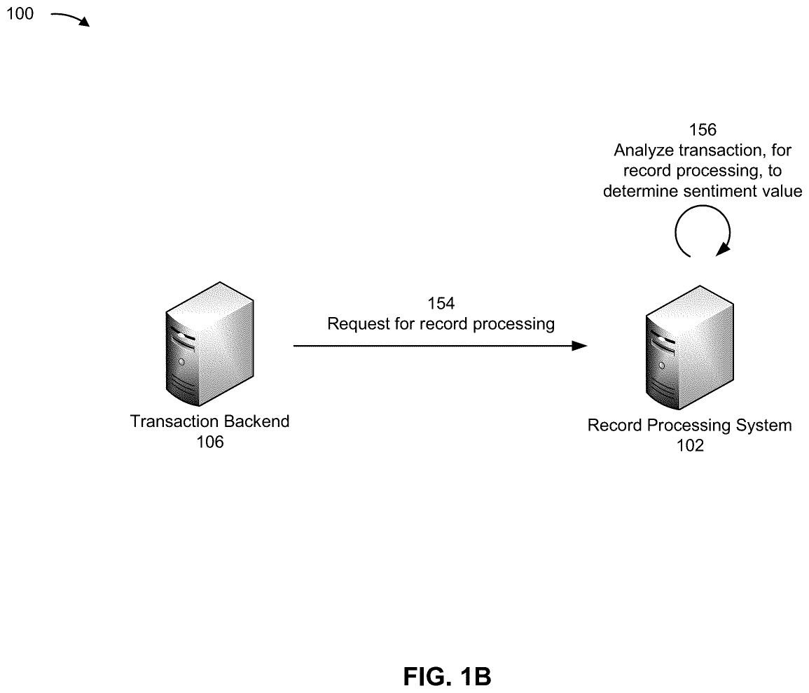

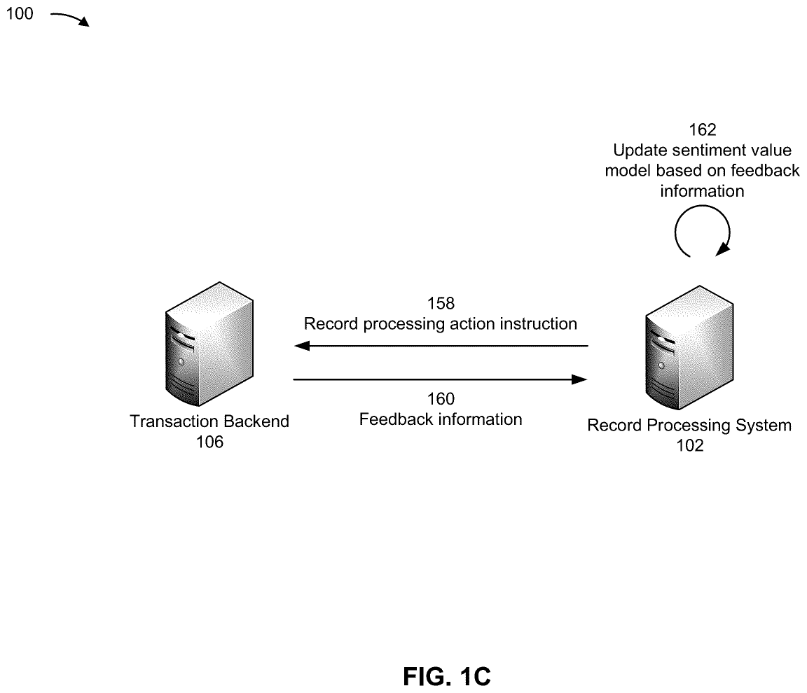

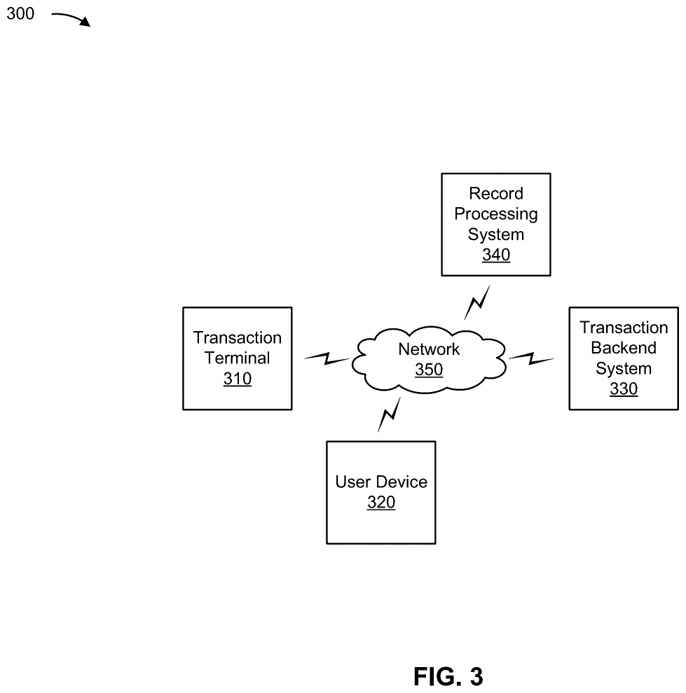

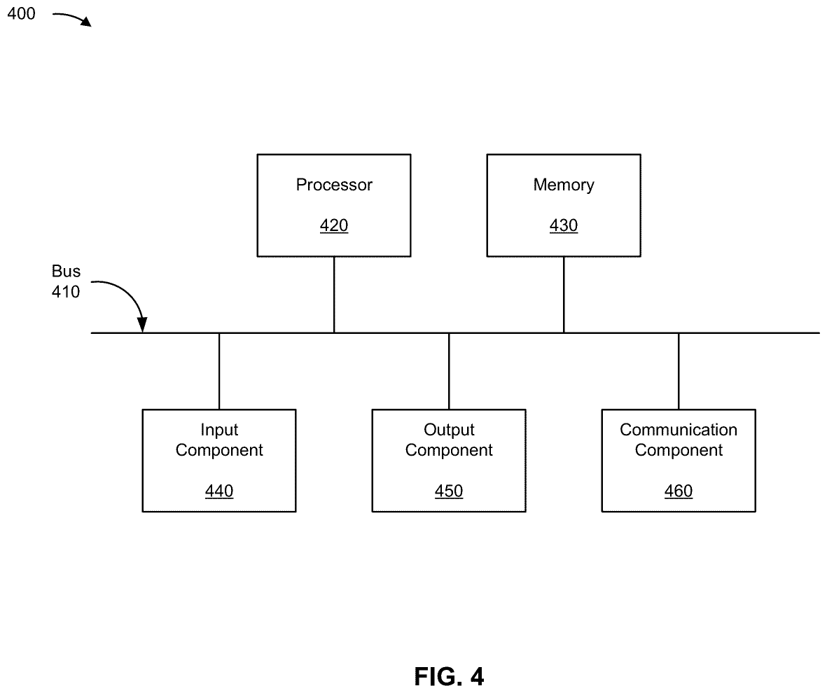

FIGS. 1A-1C are diagrams of an example implementation 100 associated with machine learning sentiment analysis for selective record processing. As shown in FIGS. 1A-1C, example implementation 100 includes a record processing system 102, a transaction data source 104, and/or a transaction backend 106. These devices are described in more detail below in connection with FIG. 3 and FIG. 4.

As further shown in FIG. 1A, and by reference number 150, the record processing system 102 may receive historical transaction data from a transaction data source 104. For example, the record processing system 102 may receive historical transaction data from a transaction backend system, a set of user devices, a set of point-of-sale (POS) devices, or a set of biometric devices, among other examples. In this case, the record processing system 102 obtains historical transaction data relating to purchases by a set of customers to train a machine learning model to analyze transactions. In another example, the record processing system 102 may receive historical editing data relating to edits made to a document or a website (e.g., a wiki that uses crowd-sourced editing). In this case, the record processing system 102 may use the historical editing data to analyze edits that are proposed for a document or a website. In another example, the record processing system 102 may receive historical data relating to access to a secure server, access to a social media account, access to a communication platform (e.g., an email account or a chat program), or access to a physical area (e.g., via an access system, such as a biometric access system used to secure a building or a room within a building), among other examples. In these other examples of access requests, the record processing system 102 may receive historical data to train a machine learning model to analyze the access requests.

In some implementations, the record processing system 102 may receive biometric training data from a biometric data source (e.g., a user device or biometric device that captures biometric data, or a server storing biometric data from a group of user devices or biometric devices). For example, the record processing system 102 may obtain information identifying data from a brain-computer interaction (BCI) headset. Additionally, or alternatively, the record processing system 102 may receive data identifying a heart rate, a blood pressure, a sweat level, a cortisol level (or another biomarker from a biomarker dataset), or a body temperature, among other examples. Additionally, or alternatively, the record processing system 102 may receive an image dataset (e.g., including an image depicting a purchaser when making a purchase or an editor when making an edit to a document). In this case, the record processing system 102 may apply image processing to extract one or more features from image data, such as a facial gesture (e.g., an indicator of an emotion or a presence of a tic) or a facial sentiment, among other examples. Additionally, or alternatively, the record processing system 102 may receive a processed record dataset (e.g., of previous processed records, such as previous transactions), a user history dataset (e.g., of a set of transactions completed by a user), or another dataset relating to transactions or other record processing requests. For example, the record processing system 102 may receive information identifying attributes of a user (e.g., a purchaser) or attributes of an entity (e.g., a vendor) that correspond to features in a trained machine learning model, as described herein.

In some implementations, the record processing system 102 may receive demographic data from a demographic data source (e.g., a user device or a server storing demographic data for a group of users). For example, the record processing system 102 may receive data identifying a location (e.g., a location at which a user makes a purchase, a home location, or a work location, among other examples), an educational background, a set of user interests, a voter registration, a consumption pattern (e.g., a set of purchases made or stores frequented), a financial pattern (e.g., a credit limit, a mortgage, or a set of investments). Additionally, or alternatively, the record processing system 102 may obtain social media activity data, advertisement engagement data, or another available demographic dataset.

In some implementations, the record processing system 102 may receive public data from a public data source (e.g., a server storing public data or a set of websites that are parsed to extract public data). For example, the record processing system 102 may receive data identifying a set of holidays, a set of events (e.g., sports events, political events, or other news events), or weather events, among other examples.

In some implementations, the record processing system 102 may apply one or more anonymization techniques to obtained data. For example, the record processing system 102 may apply anonymization techniques such as aggregation, generalization, masking, redaction, perturbation, tokenization, differential privacy, simulated data generation, or synthetic data generation, among other examples, to ensure that obtained personal information is protected. For example, with respect to a transaction dataset, anonymization may be applied to a time or date, a location, a purchaser, a vendor, a purchase location, an item that is purchased, a price, or a purchase method, among other examples. In some implementations, the record processing system 102 may be configured with a set of compliance guidelines, such as health privacy compliance guidelines, personal privacy guidelines, or financial information privacy compliance guidelines, and may analyze obtained data and output a certification of compliance with the set of compliance guidelines. In other words, the record processing system 102 may apply an anonymization technique to data and may output an indication that the data has been anonymized in accordance with a set of compliance guidelines. Additionally, or alternatively, the record processing system 102 may be configured to use opt-in or opt-out functionalities (or other privacy functionalities) to enable users to select which data is captured for use in training a machine learning model, as described herein.

As further shown in FIG. 1A, and by reference number 152, the record processing system 102 may train a sentiment value model (e.g., a sentiment analysis model trained to determine a sentiment value associated with a record processing request). For example, the record processing system 102 may train the sentiment value model to determine a sentiment associated with a transaction, an edit request, or an access request, among other examples. In this case, the record processing system 102 may extract features from the datasets that are received and may determine correlations between different features that indicate an emotional state of a purchaser and a correlation between the emotional state and whether an item was returned, an edit was rejected, an access was associated with a negative outcome, or another correlation, as described in more detail herein.

As shown in FIG. 1B, and by reference number 154, the record processing system 102 may receive a request for record processing from, for example, the transaction backend 106. For example, the record processing system 102 may receive a request to process a transaction for an item. Additionally, or alternatively, the record processing system 102 may receive a request to process an edit to a document or a request to process a set of access credentials for access. In some implementations, the record processing system 102 may correlate the request for record processing with one or more other candidate records for processing (e.g., within a threshold time period of the record being requested for processing). For example, the record processing system 102 may determine that a user is making a set of transactions (or a single transaction with a set of items). In this case, the record processing system 102 may user a combination of attributes associated with the record for processing and the one or more other candidate records for processing to determine the sentiment value using the sentiment value model.

In some implementations, the record processing system 102 may obtain information from which to extract features for analysis using the sentiment value model. For example, the record processing system 102 may obtain a biometric dataset from a biometric device or a biometric record from a user device (e.g., identifying a biometric profile or biomarker profile of a user). Additionally, or alternatively, the record processing system 102 may obtain information from the transaction backend 106 or a POS device indicating an item that is being purchased in connection with the transaction. Additionally, or alternatively, the record processing system 102 may receive information identifying a set of proposed edits or a document that is being edited from a document server. Additionally, or alternatively, the record processing system 102 may receive information indicating a type of access that is being requested from an access server.

In some implementations, the record processing system 102 may be configured in connection with receiving the request. For example, the record processing system 102 may be configured by a user of a user device to detect a configured type (or pre-selected type) of request, such as a transaction request on a particular user device. As an example, a parent may configure, via a browser extension in a web browser, that when a child is using a computer, the record processing system 102 is to use a sentiment value determination to determine whether to allow transactions or access by the child and/or whether to transmit one or more alerts to the parent's user device in connection with the transactions or access, as described herein. Additionally, or alternatively, a person may self-configure a web browser extension to, for example, detect sentiment values for transactions in a particular category that the user intends to avoid when in a negative emotional state. For example, a user may configure the record processing system 102 to identify the sentiment value for clothes purchases, thereby allowing the user to make clothes purchases when in a positive emotional state but preventing the user from making clothes purchases when in a negative emotional state. Other types of opt-in or opt-out configurations are contemplated in connection with a user and/or any relevant privacy or confidential data policies.

Additionally, or alternatively, a service provider may configure the record processing system 102 on behalf of a user. For example, a health insurance provider may provide a discount to a user for allowing the record processing system 102 to be configured to analyze a sentiment associated with purchases, thereby enabling the user to have assistance in avoiding emotionally driven purchases of cigarettes, alcohol, or junk food, among other examples. Similarly, an employer may configure the record processing system 102 to enable blocking of access to company files or company social media accounts when a user is determined to be in a negative emotional state, thereby avoiding damage to the company or liability. Additionally, or alternatively, a bank may configure the record processing system 102 to analyze transactions to use sentiment values and correlated emotional states as information in determining whether suspicious banking activity is occurring, thereby enabling fraud prevention and/or compliance with regulations relating to preventing illegal banking activity.

As further shown in FIG. 1B, and by reference number 156, the record processing system 102 may analyze the request for record processing and determine a sentiment value. For example, the record processing system 102 may use the sentiment value model to determine a sentiment value associated with a transaction. Additionally, or alternatively, the record processing system 102 may use the sentiment value model to determine a sentiment value associated with an edit request or an access request. In some implementations, the record processing system 102 may determine whether the sentiment value satisfies a threshold. For example, the record processing system 102 may determine that the sentiment value is greater than or equal to a threshold indicating positive sentiment or lack of negative emotion (e.g., the user is unlikely to regret a purchase, an edit is unlikely to be rejected, or access is unlikely to be used in a negative manner, such as to make social media posts that will be regretted). In this case, the record processing system 102 may determine that the request for record processing is to be approved. Additionally, or alternatively, the record processing system 102 may determine that the sentiment value does not exceed the threshold, thereby indicating a negative sentiment or a presence of negative emotion (e.g., the user is likely to regret a purchase, an edit is likely to be rejected, or access is likely to be used in a negative manner). In this case, the record processing system 102 may determine not to approve the request for record processing, as described in more detail herein.

As shown in FIG. 1C, and by reference number 158, the record processing system 102 may transmit, to, for example, the transaction backend 106, a record processing action instruction. For example, the record processing system 102 may transmit an instruction to process the requested transaction, edit, or access credential. In this case, the record processing system 102 may communicate with the transaction backend 106, a POS device, an ATM, a document server, an access server, or another device to approve the request to process the record. Accordingly, the user may have a transaction processed, money provided from an ATM, an edit incorporated into a document (or access to the document for editing), or access to a location (e.g., access to a secure facility) or account (e.g., access to a social media account for posting).

Additionally, or alternatively, the record processing system 102 may transmit an instruction associated with rejecting the request to process the record. For example, the record processing system 102 may cause a delay to a transaction for a particular period of time. In this case, the record processing system 102 may select the period of time based on a pre-configured time interval, based on the sentiment value (e.g., different sentiment values may have different periods of time), or based on another factor (e.g., different levels, such as different price thresholds, return cost thresholds, or return carbon footprint thresholds, may be associated with different delays), among other examples. Additionally, or alternatively, the record processing system 102 may deny the requested transaction, edit, or access credential. Additionally, or alternatively, the record processing system 102 may provide an alert. For example, the record processing system 102 may transmit an alert for display on a user device of a user indicating that the request is not approved (which may allow the user to override the approval). Additionally, or alternatively, the record processing system 102 may transmit an alert for display on another user device. For example, a parent may have configured an alert such that when a child's transaction request is denied, the parent can override the transaction denial and approve the transaction.

Additionally, or alternatively, when a sentiment value is detected indicating a negative emotion and a transaction is associated with items that correlate to illegal activity, the record processing system 102 may automatically alert a law enforcement system regarding the potential for illegal activity. In other words, the record processing system 102 may disambiguate between a person in an emotional state associated with illness, who is purchasing medicine for personal use, from a person who is in an emotional state associated with illegal or unapproved activity, who is purchasing the same medicine for use in connection with the illegal or unapproved activity. As another example, when a sentiment value is detected indicating a negative emotion and a transaction associated with, for example, leaving a jurisdiction illegally, the record processing system 102 may alert law enforcement in connection with an attempt to leave a jurisdiction illegally.

In some implementations, the record processing system 102 may automatically perform another action. For example, when the record processing system 102 rejects a transaction for renting a shared bicycle or scooter based on a sentiment value and a set of alcohol purchases in a transaction history, the record processing system 102 may enable automatic approval or may automatically schedule a ride share ride for the user to ensure safe travel. Similarly, the record processing system 102 may determine to deny high value transactions or access to a social media account for a configured period of time after alcohol purchases and in connection with a negative sentiment, but may allow configured transactions, such as ride share purchases or taxi cab payments during the threshold period of time. In some implementations, the record processing system 102 may adjust a marketing configuration based on a sentiment value. For example, the record processing system 102 may cause marketing of a configured set of items to be prioritized in connection with a sentiment value, such as causing more expensive graduation gifts to be displayed at a top of a webpage (or cause another type of layout change to a webpage) when a device user is detected to be at a first sentiment value level of excitement regarding a child's graduation (e.g., and is determined to be likely to purchase larger, more expensive balloons and catering for party or more expensive items as gifts). In contrast, when the user is determined to be at a second sentiment value level of excitement, the record processing system 102 may cause less expensive items to be displayed at a top of the webpage, thereby helping the user avoid emotional purchases that the user will later regret.

In some implementations, the record processing system 102 may provide information to a user based on a sentiment value determination. For example, when the record processing system 102 detects that an expensive purchase is based on emotion, the record processing system 102 may provide access to financial literacy information, budgeting information, or self-help information to assist a user in making financially sound decisions. In this case, the record processing system 102 may communicate with a browser extension installed on a user's user device to enable information to be provided for display to the user and/or to pause user activity for a configured period of time to prevent other transactions from being initiated. Additionally, or alternatively, the record processing system 102 may communicate with another device, such as the transaction backend 106, to cause a temporary pause to be placed on a user's credit card or a user device to cause a temporary pause to a tap-to-pay functionality on the user device.

In some implementations, the record processing system 102 may transmit an alert to a configured sponsor of a user (e.g., an Alcoholics Anonymous sponsor, a nutritionist, a physician, a relative, or a personal trainer) when a sentiment value associated with negative behavior is detected and a purchase is within a configured group of purchase types (e.g., alcohol purchases or other items in a configured group). In this case, the record processing system 102 can enable the user to remain on a path toward the user's goals by enabling the user (with the help of a sponsor) to avoid purchases or behavior that deviates from the user's goal as a result of, for example, a negative emotional state. Although some aspects are described in terms of rejecting transactions based on a negative emotional state, it is contemplated that the record processing system 102 may reject transactions based on an excessively positive emotional state, such as rejecting an expensive purchase made by a sports fan after the sports fan's team is victorious or by a gambler after a successful bet is won. Similarly, other “excessive” emotional states may be detected, such as a tired state, an intoxicated state, a confused state (e.g., when shopping in a location where the user does not understand the language), or another state, which may trigger the record processing system 102 to, in connection with a sentiment value, reject or otherwise take an action regarding a transaction, edit, or access request, as described herein.

In some implementations, the record processing system 102 may use the sentiment value to determine an effectiveness of a promotion. For example, when a reward is provided to a shopper, such as a discount, coupon, or free item, the record processing system 102 may use the sentiment value to rate an effectiveness of the reward. In this case, the record processing system 102 may update a profile of a user to indicate which awards result in a highest level of positive emotion. Additionally, or alternatively, the record processing system 102 may alert a merchant regarding an incentive to provide a purchaser (e.g., to remove an unhealthy item from a cart) or regarding a promotion for the purchaser (e.g., to provide a discount on a more healthy item when the purchaser is determined to have a negative emotional state).

As further shown in FIG. 1C, and by reference numbers 160 and 162, the record processing system 102 may receive feedback information and update the sentiment value model. For example, the record processing system 102 may receive information indicating whether an item, which was approved for purchase, was subject to a return or refund request. Additionally, or alternatively, the record processing system 102 may receive information indicating whether an item, which was not approved for purchase, was subsequently purchased by a user. Additionally, or alternatively, the record processing system 102 may receive a result of a further review of the request, such as a result indicating that an escalation editor approved a request to edit a document, which was flagged for further review by the escalation editor as a result of the sentiment value. Additionally, or alternatively, the record processing system 102 may transmit an alert to a user and the user may provide feedback indicating whether the record processing system 102 was correct in an assessment of an emotional state using the sentiment value.

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

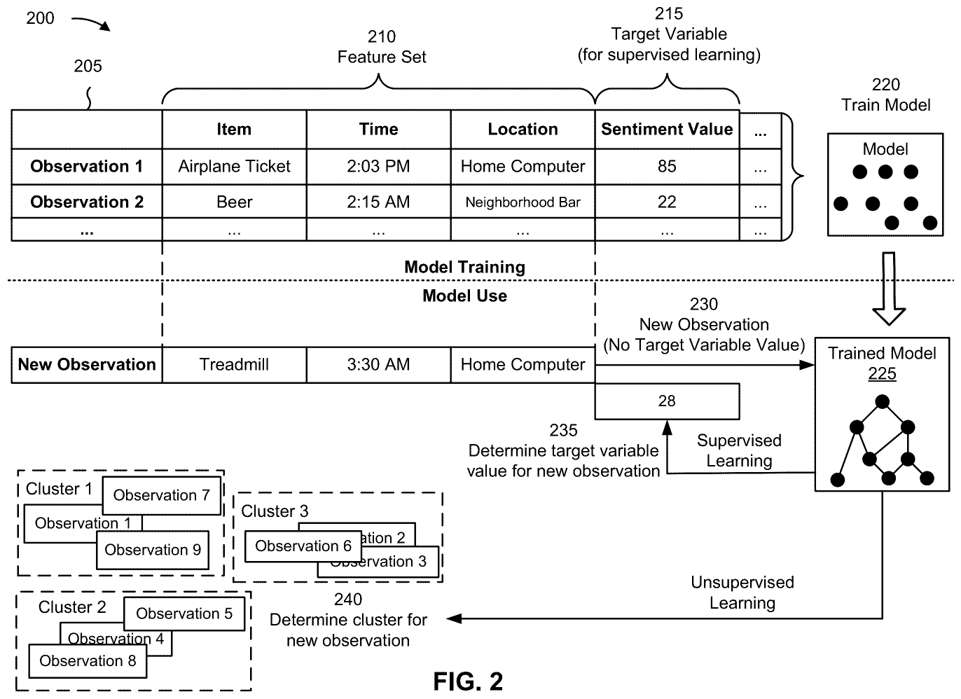

FIG. 2 is a diagram illustrating an example 200 of training and using a machine learning model in connection with machine learning sentiment analysis. The machine learning model training and usage described herein may be performed using a machine learning system. The machine learning system may include or may be included in a computing device, a server, a cloud computing environment, or the like, such as the record processing system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from a transaction backend system, a transaction terminal, or a user device, among other examples, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the transaction backend system, the transaction terminal, or the user device, among other examples, as described elsewhere herein. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of an item, a second feature of a time, a third feature of a location, and so on. As shown, for a first observation, the first feature may have a value of “airplane ticket”, the second feature may have a value of “2:03 PM”, the third feature may have a value of “home computer”, and so on. These features and feature values are provided as examples, and may differ in other examples. For example, the feature set may include one or more of the following features: merchant identifier, transaction size, transaction frequency, type of transaction (e.g., card-swipe, chip-reading, tap-to-pay, online, etc.), biometric data (e.g., brain-computer interaction (BCI) data, heart rate data, blood pressure data, sweat level data, cortisol level data, temperature data), image data (e.g., computer vision applied to an image of a user making a transaction), demographic data, social media behavior, or public data (e.g., an occurrence of known events, such as a sports team's results or an outcome of an election), among other examples. In some implementations, the feature set may be based on anonymization techniques applied to feature data. For example, the record processing system (or another system) may apply anonymization techniques to data that is used to train a machine learning model to preserve private information of users from whom the feature data was captured. As examples, data anonymization techniques that may be applied may include aggregation, generalization, masking, redaction, perturbation, tokenization, differential privacy, data encryption, synthetic data generation, or simulated data generation, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is a sentiment value, which has a value of “85” for the first observation. As described elsewhere herein, the sentiment value can be used to determine whether a transaction is likely to be regretted by the purchaser (and is likely to be subject to a return, to being discarded, or to having a refund requested).

The feature set and target variable described above are provided as examples, and other examples may differ from what is described above. For example, for a target variable of a fraud prediction, the feature set may include the sentiment value, a fraud damage rating (e.g., a value representing a damage the fraud can cause), a transaction type, or another value.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. For example, the machine learning system may use a decision tree algorithm to determine whether to accept, reject, or delay a transaction. Additionally, or alternatively, the machine learning system may use a neural network algorithm or a support vector machine algorithm to determine a likelihood that a transaction will be regretted at a later time and/or a cost associated with the transaction being regretted (e.g., whether an item will be subject to underuse, return, or discard). After training, the machine learning system may store the machine learning model as a trained machine learning model 225 to be used to analyze new observations.

As an example, the machine learning system may obtain training data for the set of observations based on records of previous transactions (e.g., items purchased, whether the transaction was cancelled or the item was returned, whether the item was listed for resale, etc.). The machine learning system may also obtain training data from user devices or POS devices (e.g., biometric data) as well as correlating the training data with public data (e.g., records of events that could affect a purchaser's mindset). The machine learning system may train the machine learning model to predict whether the purchaser's mindset is, for example, excited by an occurrence of an event, thereby resulting in the purchaser making a transaction that the purchaser will later regret for an item that the purchaser will later attempt to return. In this case, when the machine learning system identifies such a transaction, as described below, the machine learning system may recommend that the transaction be delayed (e.g., to allow the purchaser's mindset to return to a non-affected state) or rejected, among other examples.

As shown by reference number 230, the machine learning system may apply the trained machine learning model 225 to a new observation, such as by receiving a new observation and inputting the new observation to the trained machine learning model 225. As shown, the new observation may include a first feature of an item, a second feature of a time, a third feature of a location, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of “28” for the target variable of a sentiment value for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, to reject a transaction. The first automated action may include, for example, causing a POS device to forgo processing a credit card and causing the credit card to be rejected.

As another example, if the machine learning system were to predict a higher sentiment value, then the machine learning system may provide a second (e.g., different) recommendation (e.g., to approve a transaction) and/or may perform or cause performance of a second (e.g., different) automated action (e.g., cause a POS device to process a credit card successfully).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., “purchases that a person will regret within 12 hours”), then the machine learning system may provide a first recommendation, such as causing a transaction to be delayed (e.g., for 12 hours), thereby allowing the person time to change their mindset and determine whether they really want to complete a purchase. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., “purchases that are likely to be returned”), then the machine learning system may provide a second (e.g., different) recommendation (e.g., that a price (or carbon footprint) for returning the item be provided for display on a person's user device, thereby alerting the person to a cost (or carbon footprint) associated with returning the item).

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include whether a person proceeded with a transaction after a transaction was delayed, whether a person returned an item after a transaction was approved, or user feedback on whether delaying or rejecting a transaction resulted in negative user experience, among other examples.

In this way, the machine learning system may apply a rigorous and automated process to record processing, such as for transaction processing. The machine learning system may enable recognition and/or identification of tens, hundreds, thousands, or millions of features and/or feature values for tens, hundreds, thousands, or millions of observations, thereby increasing accuracy and consistency and reducing delay associated with sentiment analysis relative to requiring computing resources to be allocated for tens, hundreds, or thousands of operators to manually identify a sentiment associated with a transaction using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a transaction terminal 310, a user device 320, a transaction backend system 330, a record processing system 340, and a network 350. Devices of environment 300 may interconnect via wired connections, wireless connections, or a combination of wired and wireless connections.

The transaction terminal 310 may include one or more devices capable of facilitating an electronic transaction. For example, the transaction terminal 310 may include a point-of-sale (POS) terminal, a payment terminal (e.g., a credit card terminal, a contactless payment terminal, a mobile credit card reader, or a chip reader), and/or an automated teller machine (ATM). In some implementations, the transaction terminal 310 may include an access control terminal (e.g., used to control physical access to a secure area), such as an access control panel used to control an access-controlled entry (e.g., a turnstile, a door, a gate, or another physical barrier). The transaction terminal 310 may include one or more input components and/or one or more output components to facilitate obtaining data (e.g., account information) from a transaction device (e.g., a transaction card, a mobile device executing a payment application, or the like) and/or to facilitate interaction with and/or authorization from an owner or accountholder of the transaction device. Example input components of the transaction terminal 310 include a number keypad, a touchscreen, a magnetic stripe reader, a chip reader, and/or a radio frequency (RF) signal reader (e.g., a near-field communication (NFC) reader). Example output devices of transaction terminal 310 include a display and/or a speaker.

The user device 320 may include one or more devices capable of receiving, generating, storing, processing, and/or providing information associated with generating a record for processing, as described elsewhere herein. The user device 320 may include a communication device and/or a computing device. For example, the user device 320 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The transaction backend system 330 may include one or more devices capable of processing, authorizing, and/or facilitating a transaction. For example, the transaction backend system 330 may include one or more servers and/or computing hardware (e.g., in a cloud computing environment or separate from a cloud computing environment) configured to receive and/or store information associated with processing an electronic transaction. The transaction backend system 330 may process a transaction, such as to approve (e.g., permit, authorize, or the like) or decline (e.g., reject, deny, or the like) the transaction and/or to complete the transaction if the transaction is approved. The transaction backend system 330 may process the transaction based on information received from a transaction terminal, such as transaction data (e.g., information that identifies a transaction amount, a merchant, a time of a transaction, a location of the transaction, or the like), account information communicated to the transaction terminal by a transaction device (e.g., a transaction card, a mobile device executing a payment application, or the like) and/or information stored by the transaction backend system 330 (e.g., for fraud detection).

The transaction backend system 330 may be associated with a financial institution (e.g., a bank, a lender, a credit card company, or a credit union) and/or may be associated with a transaction card association that authorizes a transaction and/or facilitates a transfer of funds. For example, the transaction backend system 330 may be associated with an issuing bank associated with the transaction device, an acquiring bank (or merchant bank) associated with the merchant and/or the transaction terminal, and/or a transaction card association (e.g., VISA® or MASTERCARD®) associated with the transaction device. Based on receiving information associated with the transaction device from the transaction terminal, one or more devices of the transaction backend system 330 may communicate to authorize a transaction and/or to transfer funds from an account associated with the transaction device to an account of an entity (e.g., a merchant) associated with the transaction terminal.

The record processing system 340 may include one or more devices capable of receiving, generating, storing, processing, providing, and/or routing information associated with selective processing of a record, as described elsewhere herein. The record processing system 340 may include a communication device and/or a computing device. For example, the record processing system 340 may include a server, such as an application server, a client server, a web server, a database server, a host server, a proxy server, a virtual server (e.g., executing on computing hardware), or a server in a cloud computing system. In some implementations, the record processing system 340 may include computing hardware used in a cloud computing environment.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with machine learning sentiment analysis. The device 400 may correspond to the transaction terminal 310, the user device 320, the transaction backend system 330, and/or the record processing system 340. In some implementations, the transaction terminal 310, the user device 320, the transaction backend system 330, and/or the record processing system 340 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

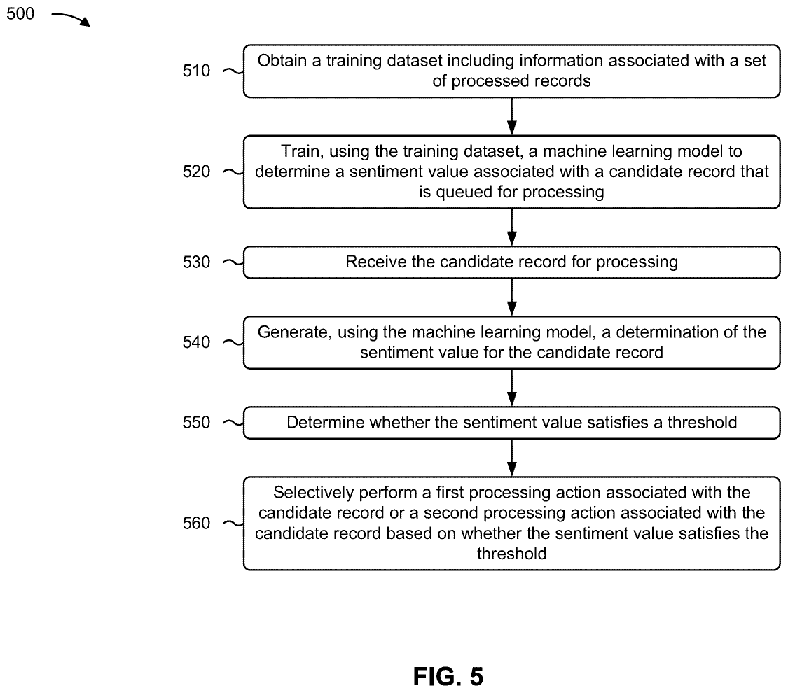

FIG. 5 is a flowchart of an example process 500 associated with machine learning sentiment analysis for selective record processing. In some implementations, one or more process blocks of FIG. 5 may be performed by the record processing system 340. In some implementations, one or more process blocks of FIG. 5 may be performed by another device or a group of devices separate from or including the record processing system 340, such as the transaction terminal 310, the user device 320, and/or the transaction backend system 330. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include obtaining a training dataset including information associated with a set of processed records (block 510). For example, the record processing system 340 (e.g., using processor 420 and/or memory 430) may obtain a training dataset including information associated with a set of processed records, as described above in connection with reference number 150 of FIG. 1A. As an example, the record processing system 340 may receive historical transaction data identifying a set of transactions, biometric data associated with the set of transactions, or return or resale data associated with the set of transactions, among other examples. As another example, the record processing system 340 may receive historical data identifying a set of edits to a document, whether the edits were reverted in another version of the document, whether the edits were approved in a review of the document, or a quality rating for the edits to the document, among other examples.

As further shown in FIG. 5, process 500 may include training, using the training dataset, a machine learning model to determine a sentiment value associated with a candidate record that is queued for processing (block 520). For example, the record processing system 340 (e.g., using processor 420 and/or memory 430) may train, using the training dataset, a machine learning model to determine a sentiment value associated with a candidate record that is queued for processing, as described above in connection with reference number 152 of FIG. 1A. As an example, the record processing system 340 may train a machine learning model to identify a sentiment score associated with a transaction. As another example, the record processing system 340 may train a machine learning model to identify a sentiment score associated with an edit to a document.

As further shown in FIG. 5, process 500 may include receiving the candidate record for processing (block 530). For example, the record processing system 340 (e.g., using processor 420, memory 430, input component 440, and/or communication component 460) may receive the candidate record for processing, as described above in connection with reference number 154 of FIG. 1B. As an example, the record processing system 340 may receive a request to process a transaction. As another example, the record processing system 340 may receive a request to approve an edit to a document.

As further shown in FIG. 5, process 500 may include generating, using the machine learning model, a determination of the sentiment value for the candidate record (block 540). For example, the record processing system 340 (e.g., using processor 420 and/or memory 430) may generate, using the machine learning model, a determination of the sentiment value for the candidate record, as described above in connection with reference number 156 of FIG. 1B. As an example, the record processing system 340 may determine a sentiment value for a purchaser attempting to purchase an item. As another example, the record processing system 340 may determine a sentiment value for an editor attempting to edit a document.

As further shown in FIG. 5, process 500 may include determining whether the sentiment value satisfies a threshold (block 550). For example, the record processing system 340 (e.g., using processor 420 and/or memory 430) may determine whether the sentiment value satisfies a threshold, as described above in connection with reference number 156 of FIG. 1B. As an example, the record processing system 340 may determine whether the sentiment value indicates that the purchaser is likely to regret the transaction. As another example, the record processing system 340 may determine whether the document edit indicates that the edit is likely to be reverted or rejected.

As further shown in FIG. 5, process 500 may include selectively performing a first processing action associated with the candidate record or a second processing action associated with the candidate record based on whether the sentiment value satisfies the threshold (block 560). For example, the record processing system 340 (e.g., using processor 420 and/or memory 430) may selectively perform a first processing action associated with the candidate record or a second processing action associated with the candidate record based on whether the sentiment value satisfies the threshold, as described above in connection with reference number 158 of FIG. 1C. As an example, the record processing system 340 may approve the transaction when the sentiment value is at a first level (e.g., greater than or equal to the threshold) and may reject the transaction when the sentiment value is at a second level (e.g., less than the threshold). As another example, the record processing system 340 may approve the edit or reject the edit based on whether the sentiment value satisfies the threshold.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for machine learning based processing, the system comprising:
one or more memories; and
one or more processors, communicatively coupled to the one or more memories, configured to:
obtain a training dataset including information associated with a set of processed records;
train, using the training dataset, a machine learning model to determine a sentiment value associated with a candidate record that is queued for processing;
generate, using the machine learning model, a determination of the sentiment value for the candidate record;
receive the candidate record for processing;
determine whether the sentiment value satisfies a threshold; and
selectively perform a first processing action associated with the candidate record or a second processing action associated with the candidate record based on whether the sentiment value satisfies the threshold.

2. The system of claim 1, wherein the training dataset includes at least one of:
a biometric dataset,
a biomarker dataset,
an image dataset,
a processed record dataset,
a demographic dataset, or
a user history dataset.

3. The system of claim 1, wherein the one or more processors, when configured to generate the determination of the sentiment value, are further configured to:
determine one or more attributes of the candidate record, the one or more attributes corresponding to one or more features of the machine learning model; and
generate the determination of the sentiment value based on the one or more attributes of the candidate record.

4. The system of claim 3, wherein the one or more attributes include at least one of:
an attribute relating to a user associated with the candidate record for processing, or
an attribute relating to an entity associated with the candidate record for processing.

5. The system of claim 1, wherein the first processing action is associated with successfully processing the candidate record; and
wherein the second processing action is associated with at least one of:
delaying processing of the candidate record, or
rejecting processing of the candidate record.

6. The system of claim 1, wherein the one or more processors are further configured to:
adjust a layout or order of one or more elements of a webpage based on the sentiment value.

7. A non-transitory computer-readable medium storing a set of instructions, the set of instructions comprising:
one or more instructions that, when executed by one or more processors of a device, cause the device to:
obtain a training dataset including information associated with a set of processed records;
train, using the training dataset, a machine learning model to determine a sentiment value associated with a candidate record that is queued for processing;
receive the candidate record for processing;
generate, using the machine learning model, a determination of the sentiment value for the candidate record;
determine whether the sentiment value satisfies a threshold;
selectively perform a first processing action associated with the candidate record or a second processing action associated with the candidate record based on whether the sentiment value satisfies the threshold;
monitor a client device to determine a result of selectively performing the first processing action or the second processing action; and
update the machine learning model based on the result of selectively performing the first processing action or the second processing action.

8. The non-transitory computer-readable medium of claim 7, wherein the determination of the sentiment value is associated with a determination of an emotional state of a user requesting processing of the candidate record, the machine learning model being a sentiment analysis model for determining the emotional state of the user.

9. The non-transitory computer-readable medium of claim 7, wherein the one or more instructions, that cause the device to generate the determination of the sentiment value, cause the device to:
identify one or more other records processed within a threshold time period of generation of the candidate record,
the one or more records being of a pre-selected type; and
generate the determination of the sentiment value based on the one or more other records.

10. The non-transitory computer-readable medium of claim 9, wherein the candidate record is of another pre-selected type relating to the pre-selected type of the one or more other records; and
wherein the one or more instructions, that cause the device to generate the determination of the sentiment value, cause the device to:
generate the determination of the sentiment value based on the candidate record being of the other pre-selected type relating to the pre-selected type of the one or more other records.

11. The non-transitory computer-readable medium of claim 7, wherein the one or more instructions, that cause the device to generate the determination of the sentiment value, cause the device to:
identify one or more other records,
the one or more other records being previously processed records or other candidate records for processing,
a combination of the record and the one or more other records being a pre-selected type of combination; and
generate the determination of the sentiment value based on the one or more other records.

12. The non-transitory computer-readable medium of claim 7, wherein the one or more instructions further cause the device to:
transmit one or more alerts to one or more third party entities based on the sentiment value.

13. The non-transitory computer-readable medium of claim 7, wherein the one or more instructions further cause the device to:
adjust a layout or order of one or more elements of a webpage based on the sentiment value.

14. A method, comprising:
receiving, by a device, a candidate record for processing;
generating, using a machine learning model associated with determining a sentiment value, a determination of the sentiment value for the candidate record;
determining, by the device, whether the sentiment value satisfies a threshold;
selecting, by the device, a first processing action associated with the candidate record or a second processing action associated with the candidate record based on whether the sentiment value satisfies the threshold; and
transmitting, by the device and based on selecting the first processing action or the second processing action, one or more messages associated with causing the first processing action or the second processing action to be performed.

15. The method of claim 14, wherein a training dataset for the machine learning model includes at least one of:
a biometric dataset,
a biomarker dataset,
an image dataset,
a processed record dataset,
a demographic dataset, or
a user history dataset.

16. The method of claim 14, wherein configuring to generate the determination of the sentiment value comprises:
determining one or more attributes of the candidate record, the one or more attributes corresponding to one or more features of the machine learning model; and
generating the determination of the sentiment value based on the one or more attributes of the candidate record.

17. The method of claim 14, further comprising:
transmitting one or more alerts to one or more third party entities based on the sentiment value.

18. The method of claim 14, further comprising:
adjusting a layout or order of one or more elements of a webpage based on the sentiment value.

19. The method of claim 14, further comprising:
transmitting an alert to a pre-selected device based on the sentiment value.

20. The method of claim 14, further comprising:
transmitting an alert to a browser extension associated with a client device requesting processing of the candidate record, based on the sentiment value, to trigger a function of the browser extension.
